(19) United States
(12) Patent Application Publication
(10) Pub. No.: US 2015/0114382 A1
(43) Pub. Date: Apr. 30, 2015

(54) Portable Fire Pit Cover

(71) Applicants: Sally Creach, Pasco, WA (US); Travis T. Creach, Pasco, WA (US)

(72) Inventors: Sally Creach, Pasco, WA (US); Travis T. Creach, Pasco, WA (US)

(21) Appl. No.: 14/521,819

(22) Filed: Oct. 23, 2014

Related U.S. Application Data
(60) Provisional application No. 61/897,274, filed on Oct. 30, 2013.

(51) Int. Cl. F24C 15/36; A47J 37/07

(52) U.S. Cl. CPC F24C 15/36; A47J 37/0786
USPC 126/201

(57) ABSTRACT

A portable safety enclosure for an outdoor fire pit is intended specifically for use when the fire pit or other fire container is in use and an open flame or heat source is present. The safety enclosure would prevent accidental contact with the fire container or fire pit, particularly by children or animals. The device is comprised of snap-together panels that create an enclosure around the open flame or fire pit area. Additional panels may be added for a larger enclosure, and panels may also be removed for a smaller enclosure. The panels are preferably manufactured from a heat-resistant plastic or fiberglass.

### CROSS-REFERENCE TO RELATED APPLICATIONS

This application claims the benefit of U.S. Provisional Application No. 61/897,274, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM

LISTING COMPACT DISK APPENDIX

Not Applicable

### BACKGROUND OF THE INVENTION

The invention relates generally to fire safety equipment and in particular to a portable safety enclosure for an outdoor fire pit. Preparing a bonfire or campfire for an informal outdoor social gathering can provide a desirable rustic atmosphere, but it presents a safety hazard as a guest could fall into the fire pit. A portable safety enclosure would resolve this problem. The enclosure is intended specifically for use when the fire pit or other fire container is in use or has been recently used and is hot, and would prevent accidental contact with the hot fire container, particularly by children or animals. The device is comprised of snap-together panels, preferably manufactured from a heat-resistant plastic or fiberglass material that encircle the fire container.

### SUMMARY OF THE INVENTION

Accordingly, the invention is directed to a portable safety enclosure for an outdoor fire pit. The enclosure is intended specifically for use when the fire pit or other fire container is in use or has been recently used and is hot, and would prevent accidental contact with the hot fire container, particularly by children or animals. The device is comprised of snap-together panels, preferably manufactured from a heat-resistant plastic or fiberglass material that encircle the fire container.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 shows a top view of the first exemplary embodiment, displaying the panels 10 and the fire container 14.

FIG. 2 shows a front view of a cover section component of the first exemplary embodiment, displaying the panel 10, the frame 11, the joiners 12, and the diagonal members 13.

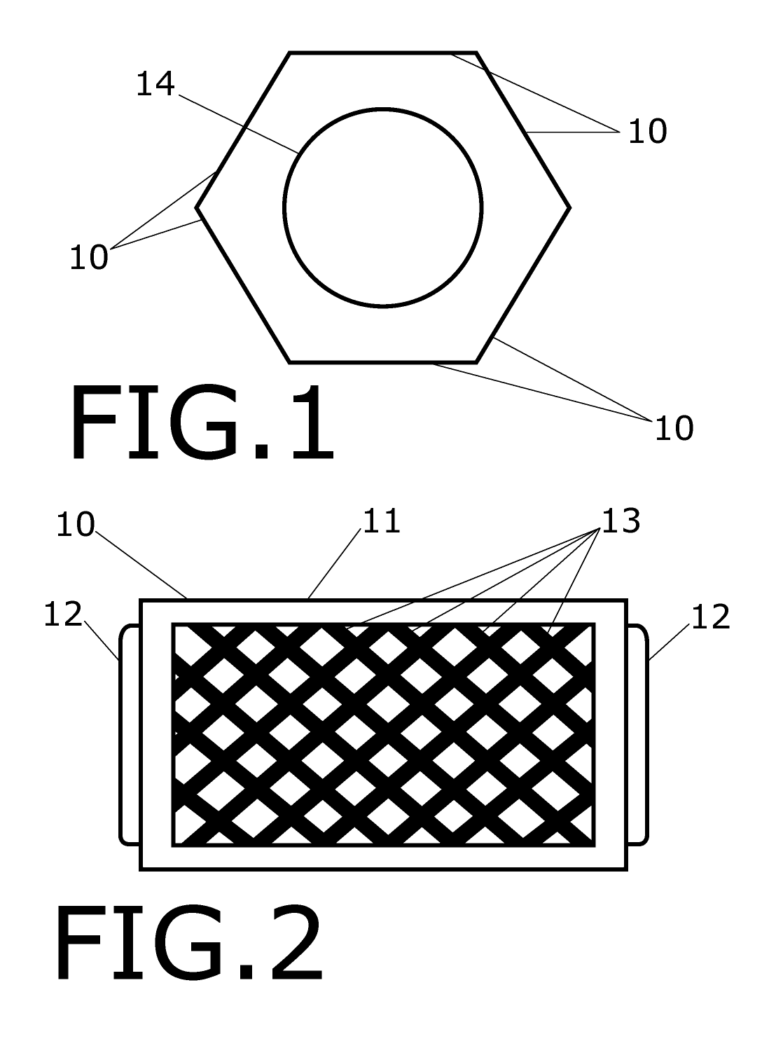

### DETAILED DESCRIPTION OF THE INVENTION

Referring now to the invention in more detail, the invention is directed to a portable safety enclosure for an outdoor fire pit. The enclosure is intended specifically for use when the fire pit or other fire container is in use or has been recently used and is hot, and would prevent accidental contact with the hot fire container, particularly by children or animals. The device is comprised of snap-together panels, preferably manufactured from a heat-resistant plastic or fiberglass material that encircle the fire container.

The first exemplary embodiment is comprised of a plurality of panels 10 which may be assembled in manner that encircles an outdoor fire pit or other fire container 14. The number of panels 10 is preferably four (square configuration) or six (hexagonal configuration as per FIG. 2). The panels 10 are preferable two and a half feet tall and three feet wide. More or fewer panels 10 are also contemplated. Each panel 10 features a rectangular frame 11 surrounding a plurality of diagonal members 13, mounted on the frame 10 at 45° angles and crossing each other at 90° angles in a crosshatch pattern, preventing the passage of any human body part through the area protected by the frame 11. At each end of the frame are joiners 12, with a male joiner 12 at one end and a female joiner 12 at the other end, enabling the user to easily snap the panels 10 together by hand, and separate them by hand. Generically a male or female joiner may be understood as a “joiner structure”.

To use the first exemplary embodiment, the user joins the panels 10 together in a closed manner so as to encircle the fire container 14, using the joiners 12. The user then places the device around the fire container both during active use of the fire container with ongoing combustion and during cool-down after the fire is extinguished. During active use, the resulting barrier lacks any top covering, thereby not constraining the fire vertically and not obstructing the users' view. After cool-down, the panels 10 may be disengaged from one another and stacked in a compact manner for storage or transport.

The panels 10 are preferably manufactured from rigid, durable materials which are heat-resistant but not conductive of heat, such as plastic or fiberglass. Notably, the material is preferably insulating such that the side of the material opposite the fire remains safe to touch. The joiners 12 are preferably manufactured from rigid, durable materials which are heat-resistant, such as plastic, fiberglass, aluminum, or steel. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

We claim:

1. A fire container enclosure comprising a plurality of panels; each of said plurality of panels being made of a material that is both heat resistant and not conductive of heat; each of said panels having affixed thereto a pair of joiner structures at opposing edges; and each of said pair of joiner structures being releasably affixable to the other; whereby said plurality of panels may be releasably joined together in a closed manner by which a fire container may be encircled.

2. The fire container enclosure of claim 1 wherein each of said plurality of panels further comprises a frame; said frame surrounding a plurality of diagonal members;
said plurality of diagonal members being configured in a crosshatch pattern.

3. The fire container enclosure of claim 1 wherein said plurality of panels is six in number, and wherein said plurality of panels form a hexagon when releasably joined together in a closed manner.

4. The fire container enclosure of claim 1 wherein said plurality of panels is four in number, and wherein said plurality of panels form a square when releasably joined together in a closed manner.

5. The fire container enclosure of claim 2 wherein said plurality of panels is six in number, and wherein said plurality of panels form a hexagon when releasably joined together in a closed manner.

6. The fire container enclosure of claim 2 wherein said plurality of panels is four in number, and wherein said plurality of panels form a square when releasably joined together in a closed manner.

7. The fire container enclosure of claim 1 wherein said plurality of panels, being releasably joined together in a closed manner, lacks any top covering.

8. The fire container enclosure of claim 2 wherein said plurality of panels, being releasably joined together in a closed manner, lacks any top covering.

9. The fire container enclosure of claim 3 wherein said plurality of panels, being releasably joined together in a closed manner, lacks any top covering.

10. The fire container enclosure of claim 4 wherein said plurality of panels, being releasably joined together in a closed manner, lacks any top covering.

11. The fire container enclosure of claim 5 wherein said plurality of panels, being releasably joined together in a closed manner, lacks any top covering.

12. The fire container enclosure of claim 6 wherein said plurality of panels, being releasably joined together in a closed manner, lacks any top covering.
